(19) United States
(12) Patent Application Publication
(10) Pub. No.: US 2002/0168208 A1
(43) Pub. Date: Nov. 14, 2002

(54) Chinese character input keyboard

(76) Inventor: Kwan-Dong Lee, Daejeon (KR)

Correspondence Address: SHANKS & HERBERT, TransPotomac Plaza, Suite 306, 1033 N. Fairfax St., Alexandria, VA, 22314, US

(21) Appl. No.: 09/864,307

(22) Filed: May 25, 2001

(30) Foreign Application Priority Data
Apr. 16, 2001 (KR) 2001-20133

(51) Int. Cl. B41J 5/08; B41J 5/26

(52) U.S. Cl. 400/484

(57) ABSTRACT

The present inventions relates to a keyboard, and more specifically to a Chinese character input keyboard, wherein having a plurality of keys, inputting Chinese characters by sequentially pressing the keys, and said keyboard comprising a plurality of radical keys for representing radicals except specific radicals which can be formed by combining another radicals defined in the Kang-Hee Chinese Dictionary, a plurality of Chinese character keys for representing one more Chinese characters which are frequently used and a plurality of combination keys for representing combination frame of a Chinese character.

According to the present invention, it is easy to input Chinese characters by pressing radical keys, Chinese character keys and combination keys, and is possible to input a lot of Chinese characters for specific time.

### BACKGROUND OF THE INVENTION

1. Field of the Invention

The present inventions relates to a keyboard, and more specifically to a Chinese character input keyboard comprising a plurality of keys representing radicals, Chinese characters and combination frame constituting a Chinese character, in order to input a Chinese character by sequentially pressing the keys.

2. Background of the Invention

There are a lot of languages in the worldwide. However, It is not simple to input all of them on a computer. Hangul alphabet or the English letter, which is composed of a consonant and a vowel, can be easily displayed on it. On the other hand, Chinese characters are particularly difficult to display on the keyboard because of their language characteristic. It's the reason that there are a large number of letters corresponding to a consonant and a vowel of the Hangul alphabet and their combination methods as well as a large number of Chinese characters to be made by themselves. In addition, there are letters which become Chinese character by themselves, and although letters do not become Chinese character by themselves, there are many letters forming Chinese character by combining any other radicals or Chinese characters.

Many kinds of keyboards for inputting Chinese characters, traditionally, have been already introduced. In general English keyboard is widely used to input Chinese character to computer. If a user input Chinese character pronunciation in English by using the keyboard, a Chinese character corresponding to the English letters is generated by a kind of computer program. For example, a user has to type the word, “hao” in English in order to generate a Chinese character, ‘ [symbol] ’ However, it is not to input Chinese character by direct stroke, but to input by converting English letter into Chinese character.

Furthermore, The stroke of Chinese character is converted into a predetermined number within a computer respectively, and an English letter corresponding to the number is then converted into Chinese character respectively. It is not easy for common user to use the method, because a user must bear in mind the number corresponding to the Chinese character stroke as well as English letter corresponding to the number.

And in the Phonetic transcription Alphabet keyboard, Phonetic transcription Alphabet corresponding to a phonetic symbol of Chinese character are displayed on the keyboard, and a user inputs the Phonetic transcription Alphabet corresponding to the phonetic symbol of the Chinese character which user desires to input into computer. Then a plurality of Chinese characters, which have been stored in advance in a database, are displayed on the screen. Subsequently, a user clicks and chooses one. However, the above method provided the same operation as Hangul alphabet inputting method and English letter inputting method does. In addition, it was not to input Chinese character directly(by direct stroke), but to input a kind of mark according to English pronunciation of a Chinese character. And then, a user selects one among the plurality of Chinese characters. In case that users could not read Chinese character they want to input, they were not able to use this method.

In addition to above keyboards, Chinese characters corresponding to the English letter are displayed on the English letter keyboard, and a plurality of radicals or Chinese characters corresponding to the displayed Chinese character are stored in the database of the computer respectively. When English alphabets corresponding to the radicals or Chinese characters constituting a Chinese character being inputted are inputted into a computer, the computer perceives the plurality of stored radicals or Chinese characters in the database respectively. Wherein, a Chinese character, which can be formed by combining all of radicals or Chinese characters, is already stored in another database. Then if English alphabets are inputted completely, the computer makes a Chinese character to be inputted. In other words, when all alphabets corresponding to each Chinese character are inputted from the left side to the right side completely, a predetermined(stored in the database in advance) Chinese character corresponding to the alphabets is displayed on the screen. However, database's capacity had to be enough to input all Chinese characters in the above method, and all of Chinese characters had to be stored in the database in advance. Moreover, users had to memorize the Chinese characters indicated on the keyboard.

However, typical keyboards are not to input Chinese characters by direct stroke, but to input them by converting them into the number, English or mark.

Accordingly, there is need to allow a keyboard, enabling rapid and efficient character-by-character input of Chinese characters from a Chinese character input keyboard having a limited set of keys.

### SUMMARY OF THE INVENTION

The present inventions relates to a keyboard, and more specifically to a Chinese character input keyboard, wherein having a plurality of keys, inputting Chinese characters by sequentially pressing the keys.

The keyboard comprising a plurality of radical keys for representing radicals defined in the Kang-Hee Chinese Dictionary, and said radicals are classified into ‘Nature’, ‘Human’, ‘Living’, ‘Animal/Plant’ and ‘the Others’ group according to their meaning, wherein said groups are positioned on some portion of said keyboard respectively, and said radical keys are positioned close to each other, a plurality of Chinese character keys for representing one more Chinese characters which are frequently used, and a plurality of combination keys for representing a combinative construction of the radicals constituting a Chinese character.

Preferably, the Chinese character keys are located above said radical keys and below said combination keys within said keyboard.

Wherein, the radical keys are composed of basic radical keys for representing basic radicals except specific radicals which can be formed by combining another radicals, and the number of said radical keys ranges between 146˜213.

The combination keys are provided at least one row above said radical keys, and the number of said combination keys ranges between 20˜35.

The radical keys comprise a radical, ‘ [symbol] ’,

in the middle of thereon, and the first radical keys according to the order of strokes of a Chinese character are positioned on the left side of said keyboard.

In addition, the ‘Nature’ group of said radical keys is further divided into ‘Recognition’ and ‘Natural object’ subgroup, and radical keys of said each subgroup are positioned close to each other, wherein the ‘Recognition’ subgroup is further divided into ‘Number’ and ‘Size’ subgroup, and radical keys representing ‘Number’ are located upper center portion of said radical keys section within said keyboard.

Furthermore, the ‘Human’ group of said radical keys is further divided into ‘Life’ and ‘Body’ subgroup, and radical keys of said each subgroup are positioned close to each other, the ‘Living’ group of said radical keys is further divided into ‘Clothing/Food/Shelter’ and ‘Artificial’ subgroup, and radical keys of said each subgroup are positioned close to each other, and the ‘Animal/Plant’ group of said radical keys is further divided into ‘Animal’ and ‘Plant’ subgroup, and radical keys of said each subgroup are positioned close to each other.

According to the present invention, it is easy to input Chinese characters by pressing radical keys, Chinese character keys and combination keys, and is possible to input a lot of Chinese characters for specific time.

### BRIEF DESCRIPTION OF THE DRAWINGS

FIG. 1 depicts a typical classification table of radicals which are indicated on keyboard according to an exemplary embodiment of the present invention.

FIG. 2 depicts a keyboard diagram according to an exemplary embodiment of the present invention.

FIG. 3 depicts topological pattern of radical keys according to an exemplary embodiment of the present invention.

FIG. 4 depicts a schematic block diagram of system to which the keyboard may be applied according to the present invention.

FIG. 5 depicts an table representing Chinese characters which are stored in the memory mean depicted in FIG. 4 in accordance with a preferred embodiment of the present invention.

### DESCRIPTION OF THE PREFERRED EMBODIMENT

Throughout the specification and claims herein of the present invention, the term “radical” refers to the least unit of a letter constituting a Chinese character. In addition, it should be noted that the order or sequence in which the stroke of a Chinese character are written or drawn is well known to those skilled in the written Chinese language.

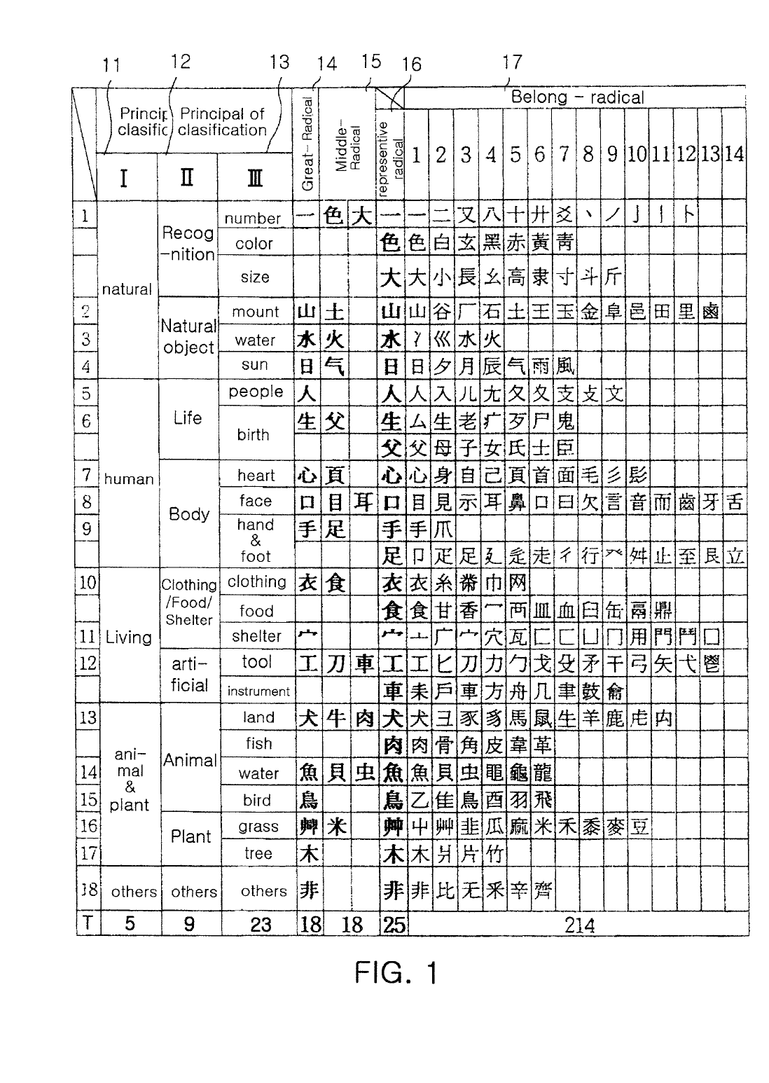

With reference now to the figures, FIG. 1 depicts a typical classification table of radicals which are indicated on keyboard according to an exemplary embodiment of the present invention. The radicals are classified into the meaning each other. Wherein, the radicals are applied to the keyboard of the present invention. Therefore, the classified radicals are explained in detail.

As shown in FIG. 1, after seizing the meaning of the 214 radicals designated from Kang-Hee Chinese Dictionary, the radicals are widely classified into five types, Group I 11; Nature; Human being; Living; Animal/plant; and the Others.

Each classification of Group I 11 is further classified into different sub-categories, Group II 12 and Group III 13. The Group II 12 is divided into ‘Recognition’, ‘Natural object’, ‘Life’, ‘Body’, ‘Clothing/Food/Shelter’, ‘Artificial’, ‘Animal’, ‘Plant’ and ‘the Others’. The ‘Recognition’ section of Group II 12 is further divided into ‘Number’, ‘Color’ and ‘Size’ section in Group III 13. The ‘Natural object’ section of Group II 12 is further divided into ‘Mont’, ‘Water’ and ‘Sun’ section in Group III 13. The ‘Life’ section of Group II 12 is further divided into ‘People’ and ‘Birth’ section in Group III 13. The ‘Body’ section of Group II 12 is further divided into ‘Heart’, ‘Face’ and ‘Limb’ section in Group III 13. The ‘Clothing/Food/Shelter’ section of Group II 12 is farther divided into ‘Clothing’, ‘Food’ and ‘Shelter’ section in Group III 13. The ‘Artificial’ section of Group II 12 is further divided into ‘Tool’ and ‘Instrument’ section in Group III 13. The “Animal” section of Group II 12 is further divided into ‘Land’, ‘Meat’, ‘Fish’ and ‘Bird’ section in Group III 13. The “Plant” section of Group II 12 is further divided into ‘Grass’ and ‘Tree’ section in Group III 13.

Each one Chinese character radical corresponding to the ‘Number’, ‘Mount’, ‘Water’, ‘Sun’, ‘People’, ‘Birth’, ‘Heart’, ‘Face’, ‘Limb’, ‘Clothing’, ‘Shelter’, ‘Tool’, ‘Land’, ‘Fish’, ‘Bird’, ‘Grass’, ‘Tree’ and ‘the Others’ is designated into Great-Radical 14. The Great-Radicals 14 are representative radical among the 214 radicals according to the classified 18 meanings. In other words, the Great-Radicals 14 are most basic and fundamental radicals from the meaning point of view among the 214 radicals. The Great-Radicals 14 are , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] ,

[symbol]

and [symbol] .

Furthermore, 18 Chinese character radicals, which relate to the Great-Radicals 14 from the meaning point of view, are designated to Middle-Radicals 15. The Middle-Radicals 15 are [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] ,

[symbol]

and [symbol] .

The Middle-Radicals 15, which have a mutual associating relation or mutual corresponding relation meaningly with the Great-Radicals 14, are designated to prevent the number of the Great-Radicals 14 increasing when the radical corresponding to Middle-Radicals 15 are classified into Great-Radicals 14. And radicals having no Belong-Radicals 17 which belong to the representative radical or having very few Belong-Radicals 17 among the classified radicals are designated as Middle-Radical 15 when the radical corresponding to Middle-Radicals 15 are classified into Great-Radicals 14.

For example, the Great-Radical 14 ‘ [symbol] ’

representing ‘Mount’ has a associating relation with Middle-Radical 15 ‘ [symbol] ’

representing ‘Earth’ from the meaning point of view, and the Great-Radical 14 ‘ [symbol] ’

representing ‘Water’ has a corresponding relation with Middle-Radical ‘ [symbol] ’

representing ‘Fire’ from the meaning point of view. Furthermore, ‘ [symbol] ’

representing ‘Mouth’ and ‘ [symbol] ’

representing ‘Eye’, ‘ [symbol] ’

representing ‘Dog’ and ‘ [symbol] ’

representing ‘Cattle’ are a mutual associating relation, and ‘ [symbol] ’

representing ‘Hand’ and ‘ [symbol] ’

representing ‘Foot’ are a mutual corresponding relation, as shown in FIG. 1.

In addition, ‘ [symbol] ’

representing ‘Fire’ can be a Great-Radical 14 from the meaning point of view, however the radical ‘ [symbol] ’

has no Belong-Radical 17. Therefore, the radical ‘ [symbol] ’

is not designated as Great-Radical 14, but as Middle-Radical 15. And ‘ [symbol] ’

representing ‘Rice’ represents grain in the radicals, however the radical ‘ [symbol] ’

is comprised of Great-Radical 14 ‘ [symbol] ’

representing ‘Grass’ from the meaning point of view. Therefore, radical ‘ [symbol] ’

is designated as a Middle-Radical 15.

In order to classify the 214 radicals, representative radicals 16 are designated by using the Great-Radicals 14 and the Middle-Radicals 15. The radicals corresponding to the classified ‘Number’, ‘Color’, ‘Size’, ‘Mount’, ‘Water’, ‘Sun’, ‘People’, ‘Birth’, ‘Heart’, ‘Face’, ‘Limb’, ‘Clothing’, ‘Food’, ‘Shelter’, ‘Tool’, ‘Instrument’, ‘Land’, ‘Meat’, ‘Fish’, ‘Bird ’, ‘Grass’, ‘Tree’ and ‘Others’ are designated as representative radicals 16 by using the Great-Radicals 14 and Middle-Radicals 15. Wherein the representative radicals 16 are designated by including some Middle-Radicals 15 with the Great-Radicals 14 or by separating some Middle-Radicals 15 from the Great-Radicals 14 in parallel with the Great-Radicals 14. And the including and parallel relations are set up in consideration of the radical's meaning, position, sequence and the number of Belong-Radicals. For example, a Middle-Radical 15 ‘ [symbol] ’

and ‘ [symbol] ’

representing ‘Color’ and ‘Size’ respectively, which is corresponds to the Great-Radical 14 ‘ [symbol] ’,

are disposed in parallel with the ‘ [symbol] ’

according to the number of Belong-Radicals 17 and the relation of the meanings, and then are representative radicals 16 respectively. Moreover, Middle-Radical 15 ‘ [symbol] ’

representing ‘Father’ is disposed in parallel with Great-Radical 14 ‘ [symbol] ’

representing ‘Life’ from the meaning point of view, Middle-Radical 15 ‘ [symbol] ’

representing ‘Foot’ is disposed in parallel with Great-Radicals 14 ‘ [symbol] ’

representing ‘Hand’ from the number of Belong-Radical 17 point of view, and Middle-Radical 15 ‘ [symbol] ’

representing ‘Food’ is disposed of in parallel with Great-Radical 14 ‘ [symbol] ’

representing ‘Clothing’, Middle-Radical 15 ‘ [symbol] ’

representing ‘Equipment or Motor’ is disposed in parallel with ‘ [symbol] ’

representing ‘Instrument’ ‘ [symbol] ’

representing ‘Meat’ is disposed in parallel with ‘ [symbol] ’

representing ‘Dog’ from the number of Belong-Radical point of view respectively. And these Middle-Radicals become an element of the 25 representative radicals 16 respectively.

In addition, ‘ [symbol] ’

representing ‘Earth’ is comprised of ‘ [symbol] ’

representing ‘Mount’, ‘ [symbol] ’ representing ‘Fire’ is of ‘ [symbol] ’

representing ‘Water’, ‘ [symbol] ’

representing ‘Spirits’ is of ‘ [symbol] ’

representing ‘Sun’, ‘ [symbol] ’

representing ‘Head’ is of ‘ [symbol] ’

representing ‘Heart’, ‘ [symbol] ’

representing ‘Eye’ and ‘ [symbol] ’

representing ‘Ear’ are of ‘ [symbol] ’

representing ‘Mouth’, ‘ [symbol] ’

representing ‘Knife’ is of ‘ [symbol] ’

representing ‘Instrument’, ‘ [symbol] ’

representing ‘Cattle’ is of ‘ [symbol] ’

representing ‘Dog’, ‘ [symbol] ’

representing ‘Shellfish’ and ‘ [symbol] ’

representing ‘Worm’ are of ‘ [symbol] ’

representing ‘Fish’, and ‘ [symbol] ’

representing ‘Rice’ is comprised of ‘ [symbol] ’

representing ‘Grass’. Therefore, the representative radicals are ‘ [symbol] ’, ‘ [symbol] ’, ‘ [symbol] ’, ‘ [symbol] ’,

‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’

and ‘ [symbol] ’.

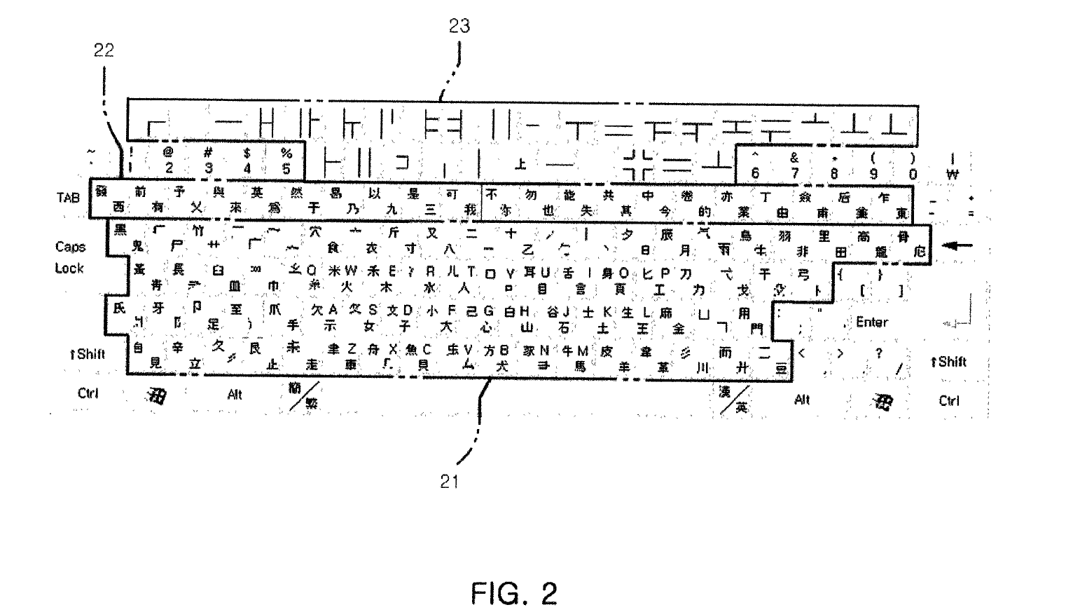

And then the rest radicals, namely Belong-Radicals 17 are arranged according to the representative radicals 16. The arrangement of the radicals is shown in FIG. 2. The rest radicals are arranged according to the meaning of them firstly, the types and positions of the radicals secondly, and then according to the connection of radical which comes next, the positions of radicals, the relation of implication, the relation of connection and the form of a character. For example, for representative radical 16 ‘ [symbol] ’, the sequence of the arrangement is as follows; Sequentially ‘ [symbol] ’

representing ‘One’ → ‘ [symbol] ’

representing ‘Two’ → ‘ [symbol] ’

representing ‘Again’ → ‘ [symbol] ’

representing ‘Eight’ → ‘ [symbol] ’

representing ‘Ten’ according to the meaning of them. And for the representative radical 16 ‘ [symbol] ’

representing ‘Mouth’, the radicals which are related to actual position of face are arranged according to the its position, such as ‘ [symbol] ’

representing ‘Eye’ → ‘ [symbol] ’

representing ‘Nose’ →‘ [symbol] ’

representing ‘Mouth’. Furthermore, for representative radical 16 ‘ [symbol] ’

representing ‘Color’, the arrangement is as follows; Sequentially ‘ [symbol] ’

representing ‘White’ → ‘ [symbol] ’

representing ‘Black’ →‘ [symbol] ’

representing ‘Black’ → [symbol] ’

representing ‘Red’ → ‘ [symbol] ’

representing ‘Yellow’ → ‘ [symbol] ’

representing ‘Blue’, wherein the arrangement is formed according to the conception of language understanding and the form of character.

Furthermore, radicals corresponding to the classified ‘Others’ are ‘ [symbol] ’, ‘ [symbol] ’, ‘ [symbol] ’, ‘ [symbol] ’, [symbol] ’

and ‘ [symbol] ’. As shown in FIG. 1, the number of Belong-Radicals 17 which belong to the representative radical 16 are less than 14. This is the reason that the rhythm such as 3, 4, 3, 4 is gave in order to study easily and remember for a long time, and if more than that, the efficiency will be lower.

Referring now to FIG. 2, FIG. 2 depicts a keyboard diagram according to an exemplary embodiment of the present invention. As shown in FIG. 2, the keyboard of the present invention includes a plurality of radical key 21 which represents rest radicals except from specific radicals that are formed by combining more than two radicals among 214 radicals classified from Kang-Hee Chinese Dictionary, a plurality of Chinese character key 22 which represents one more than Chinese characters that are frequently used in Chinese, and a plurality of combination key 23 which represents combination frame of the radicals and Chinese character constituting a Chinese character.

Preferably, the Chinese character keys 22 are positioned below the combination key 23. Also, the Chinese character keys 22 are preferably located above the radical key 21. The frequently used radical key 21 and Chinese character key 22 are located the lower portion of the keyboard, and relatively, non-frequently used combination key 23 are located the upper portion of the keyboard. Accordingly, the relative position of all these keys 21,22,23 is arranged so that a user is able to reach all these keys within a finger tip.

From bottom to top of the keyboard, the keys are regularly disposed in five key lines. And a key representing ‘ [symbol] ’

is located in the mid section of the five key lines. A plurality of Chinese character key 22, which represents one more Chinese characters that are frequently used in Chinese, are located in the top line. A plurality of radical key 21, which represents radicals except from specific radicals that can be formed by combining more than two radicals among 214 radicals from Kang-Hee Chinese Dictionary, are located in the rest four line, Furthermore, a plurality of combination keys 23, which represent combination frame of the Chinese character, are located in two line above the five line.

As described in above, the Chinese characters which are marked on the Chinese character keys 22 are frequently used in Chinese. For example, as a personal pronoun, ‘ [symbol] ’

representing ‘the first person’ and ‘ [symbol] ’

representing ‘the second person’. And ‘ [symbol] ’

representing ‘description’, ‘ [symbol] ’

representing ‘negative’, ‘ [symbol] ’

representing ‘command’ and ‘ [symbol] ’

representing ‘postposition’. And other frequently used Chinese characters, such as ‘ [symbol] ’, ‘ [symbol] ’, ‘ [symbol] ’

and ‘ [symbol] ’

are included. Moreover, frequently combining Chinese characters with other radicals or Chinese character, such as ‘ [symbol] ’, ‘ [symbol] ’, ‘ [symbol] ’

and so on. Preferably, the Chinese characters which are marked on the Chinese character key 22 are [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] , [symbol] ,

[symbol]

and [symbol] .

In addition, the radicals, which are marked on the radical key 21 of the present invention, are specific radicals except from radicals that can be formed by combining more than two radicals. In other words, 68 radicals were excepted from the 214 radicals in the Kang-Hee Character Dictionary, such as

[symbol]

which can be formed by combining ‘ [symbol] ’

and ‘+,901 ’. And the rest 146 radicals are displayed on the radical key 21. Therefore, combinative radicals, such as ‘ [symbol] ’,

are not marked on the radical key 21. The 146 basic radicals, which constitutes a Chinese character, are marked on the radical key 21. For example, ‘ [symbol] ’, ‘ [symbol] ’, [symbol] ’, ‘ [symbol] ’

and so on. Preferably, the number of said basic radicals ranges between 146˜213.

In the radicals as shown in FIG. 1, there are a few radicals which are marked in different type on the radical key 21 when the radicals are applied to the keyboard. For example, ‘ [symbol] ’

representing ‘net’ is marked as ‘ [symbol] ’

type on the radical key 21. But the meaning does not change. Moreover, as an illustrative example, in FIG. 1, the radical ‘ [symbol] ’

can be used interchangeably as of FIG. 2. Also, the radical ‘ [symbol] ’

and ‘ [symbol] ’, and radical ‘ [symbol] ’

and ‘ [symbol] ’

can be used interchangeably. There are about 32 radicals that can be used interchangeably.

The combination key 12 will be now described in detail.

Most of Chinese characters are composed of radicals. Wherein, the combination of radicals can be implemented through a combination key 12. The combination key 23 represents the composition of different radicals. For example, if a Chinese character ‘ [symbol] ’

is desired, two radicals ‘ [symbol] ’

and ‘ [symbol] ’

would be combined together, and the corresponding to the combination frame would be └ [symbol] ┘. Also, if a Chinese character ‘ [symbol] ’

is desired, two radicals ‘ [symbol] ’

and ‘ [symbol] ’

would be combined together and the corresponding to the combination frame would be └ [symbol] ┘.

In the above, it should be noted that depending on the timing of using the combination key 23, the composition of the Chinese character may change. For example, if the radical key 21, ‘ [symbol] ’,

the former combination key 23 , └ [symbol] ┘,

and the radical key 21, ‘ [symbol] ’,

are pressed in sequence, a Chinese character of ‘ [symbol] ’

will be generated. If the latter combination key 23, └ [symbol] ┘,

is pressed, a Chinese character of ‘ [symbol] ’

will be generated.

As depicted in above, in order to input a Chinese character, the combination key 12 must be inputted at second stroke. The sequence is shown in following description.

If a Chinese character being inputted is composed of two radicals, the inputting sequence is ‘radical key 21+combination key 23+radical key 21’. And if a Chinese character being inputted is composed of three radical or Chinese characters, the inputting sequence is ‘radical key 21+combination key 23+radical key 21+radical key 21’. Furthermore, in case of four, ‘radical key 21+combination key 23+radical key 21+radical key 21+radical key 21’. Therefore the combination key 23 must be inputted at second stroke as shown in above examples.

The combination keys 23 include several types, such as two-type, three-type and four-type combination key. In case that a Chinese character is composed of two radicals, a two-type combination keys are used to input the Chinese character. the two-type combination keys comprises generally more than 10 units, but the present invention provides only 6 units. In case of Chinese character comprising radicals such as ‘ [symbol] ’, ‘ [symbol] ’, ‘ [symbol] ’, ‘ [symbol] ’, ‘ [symbol] ’,

a combination frame └ [symbol] ┘

is used in common. And in case of Chinese character comprising radicals such as ‘ [symbol] ’, ‘ [symbol] ’, ‘ [symbol] ’, ‘ [symbol] ’, ‘ [symbol] ’,

a combination frame └ [symbol] ┘

is used in common. In this manner, the two-type combination key is limited to 6 units in the present invention.

The three-type combination keys are also limited to 6 units. Chinese character of inputting by three strokes in respect of the type an0d the order of strokes, and three strokes in the keying is limited to 6 units according to the characteristic of each Chinese character. And four-type combination keys are limited to 13 units in the same manner as shown in above two-type and three-type combination keys. A Chinese character comprising more than five strokes is programed to be inputted at less than four strokes. As shown in above, a Chinese character, which is composed of more than five radicals, is designated by inputting the plurality of radical or Chinese characters at less than four strokes, and can be inputted.

As shown in above description, the present invention provides the 30 representative combination keys which can be used in common among a lot of combination keys representing the all Chinese character. For example, the origin combination key corresponding to ‘ [symbol] ’

is └ [symbol] ┘

. However, └ [symbol] ┘

is used instead of that. And the origin combination key corresponding to ‘ [symbol] ’

is └ [symbol] ┘

but a combination key └ [symbol] ┘

is used instead of that. In addition, └ [symbol] ┘

is used instead of └ [symbol] ┘,

and └ [symbol] ┘

is used instead of └ [symbol] ┘.

Therefore, the common and changeable parts of combination frame of all Chinese characters are united into some combination frame, and the combination keys 23 are limited 30 units by uniting into similar frames.

The combination frame, which is represented on the combination key 23, is formed into 30 units as shown in FIG. 2 by being abstracted a plurality of some combination frame from all of Chinese characters in respect of combination frame of Chinese characters. And the combination key 23 can cover all Chinese character. In a preferred embodiment, the combination key 23 of the present invention includes all of combination frame.

The present invention provides a preferred embodiment of the combination frame. Those of ordinary skill in the art will appreciate that the combination frame, which is inputted by the combination key 23, may be modified or replaced. Moreover, a increment of the number of combination key 23 is accompanied by a space of keyboard, and a decrease of that is accompanied by the increment of keying. Therefore, the number of the combination keys 12 is preferably 20˜35.

As shown in FIG. 2, the radical ‘ [symbol] ’ representing ‘Human’ is positioned in the middle section of the radical key 21. This is done as a human signifies a center of all nature animals. Right above this radical is a radical ‘ [symbol] ’ representing ‘ME, and right below this radical lies a ‘ [symbol] ’ signifying ‘INDIVIDUAL’. The three radicals form a vertical axis. This formation of the axis is also done a human signifies a center of all nature animals. Between ‘ [symbol] ’

and ‘ [symbol] ’

lies another radicals representing ‘ [symbol] ’.

Similarly, related words for the radical ‘ [symbol] ’,

are located nearby. That is to say, a radical group relating to ‘Human’ and Living’ are positioned closely on left side of the vertical axis, and a group relating to ‘Nature’ and shape type's radicals are positioned closely together on right side of that within a keyboard.

Referring to FIG. 2, the position of the radical key 21 and Chinese character key 22 are arranged so that a user can use either hand when pressing a series of them. Because Chinese characters have no a consonant and a vowel as Hangul alphabet or English, it is difficult to divide radicals or Chinese characters on the keyboard. In order to overcome this matter, the first radicals which come first according to the order of strokes are disposed on the left side of the keyboard, and the subsequent radicals which come second and the latter according to the order of strokes are positioned on the right side of the keyboard. Accordingly, a user uses both hands by turns in pressing the keys. For example, radicals, such as └ [symbol] ┘,

└ [symbol] ┘

and └ [symbol] ┘,

that are normally associated as the initial radical in forming a Chinese character are located left side, where as [symbol] , [symbol] , [symbol] , [symbol] ,

[symbol]

etc that typically follow another radical are positioned on the right side of the keyboard. It should be noted that there are many radicals or Chinese characters which come first or latter according to the order of strokes. For example, ‘ [symbol] ’

comes first or latter in Chinese character, such as ‘ [symbol] ’

or ‘ [symbol] ’.

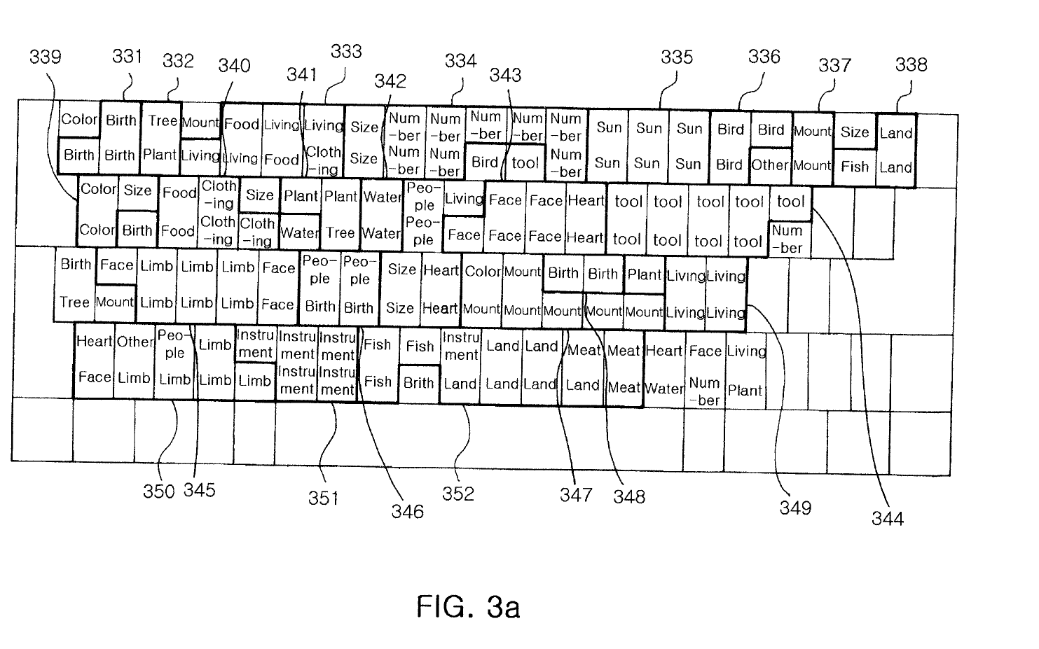

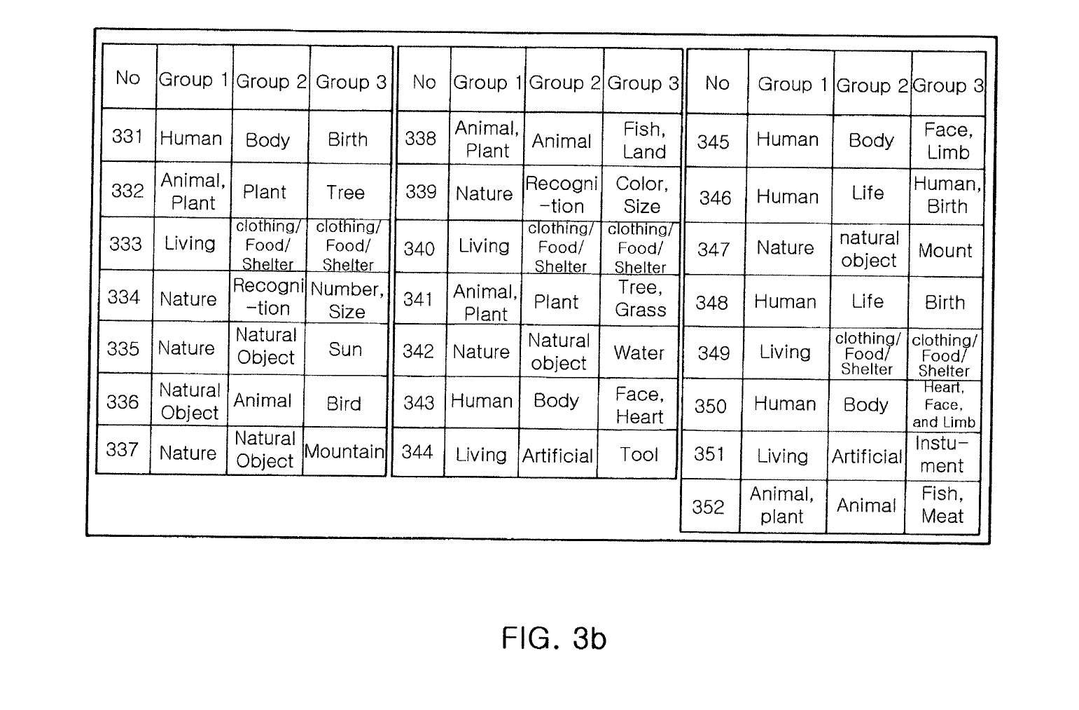

Referring now to FIG. 3, FIG. 3 shows topological pattern of radical keys according to an exemplary embodiment of the present invention. FIG. 3a depicts the disposition of the radical key 21 according to the keyboard of the present invention in FIG. 2, and FIG. 3b depicts the Group I 11, the Group II 12 and the Group III 13 according to the block NO. in FIG. 3a.

Accordingly, FIG. 3a shows the position of relative the radical key 21 reflecting the corresponding correlation table of FIG. 3b.

FIG. 3a also shows a translation of all the sub-grouping of FIG. 1. For example, radicals indicating ‘Number’, ie, [symbol] , [symbol] , [symbol] ,

and radicals indicating ‘Face’ and ‘Body’, ie, [symbol] , [symbol] , [symbol] , [symbol] ,

[symbol]

are located within the keyboard as shown in FIG. 3a. Similarly, radicals representing ‘Sun’, ie, [symbol] , [symbol] , [symbol] ,

and radical representing ‘Bird’, ie, [symbol] , [symbol] ,

[symbol]

are located within the keyboard.

As shown in FIG. 3a, a plurality of radical key 21 are classified into ‘Nature’, ‘Human’, ‘Living’, ‘Animal/Plant’ and ‘the Others’ Group I 11, and the Group I 11 are position on some portion of the keyboard. Most radicals which are composed of the Group I 11 are located closely together. For example, block no. 331 are composed of ‘Body’ Group II 22 of the ‘Human’ Group I 11, three radical keys therein are located closely together.

From the left side of the radical key 21 to the right side, ‘Body’ Group II of the ‘Human’ Group I are located, then ‘Plant’ Group II of the ‘Animal/Plant’ Group I are located. Next, ‘Clothing/Food/Shelter’ Group II of the ‘Living’ Group I are located, ‘Recognition’ Group II of the ‘Nature’ Group I are located, ‘Natural object’ Group II of the ‘Nature’ Group I are located, ‘Animal’ Group II of the ‘Animal/Plant’ Group I are located, and then ‘Natural object’ Group II of the ‘Nature’ Group I are positioned on the keyboard.

As shown in FIG. 3a, in the middle of the top line of radical key 21, radical key representing ‘Number’ 334 is provided. This is done as there is high probability of using this key. Hence, by being in the middle of the keyboard, the user may use both hands to access this key conveniently. Next to the ‘Number’ key 334 on the left side, radical key representing ‘Clothing/Food/Shelter’ 333 is provided. The radical key representing ‘Tree’ and ‘Grass’ 332 and ‘Birth’ 331 are positioned thereafter. On the right side of the ‘Number’ key 334, radical key indicating ‘Universe’ and ‘Sky’ 335,336 are provided. Thereafter, radical key indicating ‘Mount’ and ‘Fish/Land’ 337, 338 are provided.

In the second line(row) of the radical key 21 section, on the left side of radical ‘ [symbol] ’,

radical key indicating ‘Natural object’ 342 and ‘Plant’ 341 are provided. Thereafter, radical key representing ‘Clothing/Food/Shelter’ 340 and ‘Recognition’ 339 are positioned. On the right side of the radical ‘ [symbol] ’,

radical key indicating ‘Face’ 343 and ‘Tool’ 344 are provided.

In the third line(row) of the radical key section, radical key indicating ‘Limb’ 345, such as ‘Hand/Foot’, is provided and right below it, radical key indicating other ‘Limb’ 350, such as ‘Heart’ and ‘Face’, is provided. Radical key representing ‘People’ and Birth’ 346 is positioned in the third row and ‘Mount’ 347, ‘Birth’ 348 and ‘Shelter’ 349 are provided in the third row, as shown in FIG. 3a and 3b.

At the last row of the radical key section, radical ‘ [symbol] ’

is positioned in the middle section. On the left, radical ‘ [symbol] ’

and ‘ [symbol] ’

are provided respectively, and radical key representing ‘Instrument’ 351 is positioned. On the right, radical key representing ‘Meat’ and ‘Land’ 352 is positioned at the other end.

As shown in FIG. 3a, all related radicals of a Group I are positioned close to each other. In addition, the Group I are positioned on some portion of the keyboard, and positioned close to each other.

The radical key 21 which are composed of ‘Nature’ Group I is classified into ‘Recognition’ and ‘Natural object’ Group II, and is positioned close to each other. For example, in the ‘Recognition’ key 334, ‘Size’ and ‘Number’ keys are positioned close to each other.

On the left side of the vertical axis indicating ‘Human’, ie, ‘ [symbol] ’, ‘ [symbol] ’

and [symbol] ’,

radical keys representing ‘Living’ are provided and radical keys representing ‘Nature’ are provided at the other end. In detail, in the radical key indicating ‘Living’ of the left side, the radical keys representing ‘Clothing/Food/Shelter’ are positioned on the upper portion of the keyboard, and radical keys representing ‘Body’ are positioned on the lower portion. In addition, in the radical key indicating ‘Nature’ of the right side, the radical keys representing ‘Sky’ are positioned on the upper portion of the keyboard, and the radical keys representing ‘Natural object’ and ‘Land’ are positioned on the lower portion of the keyboard.

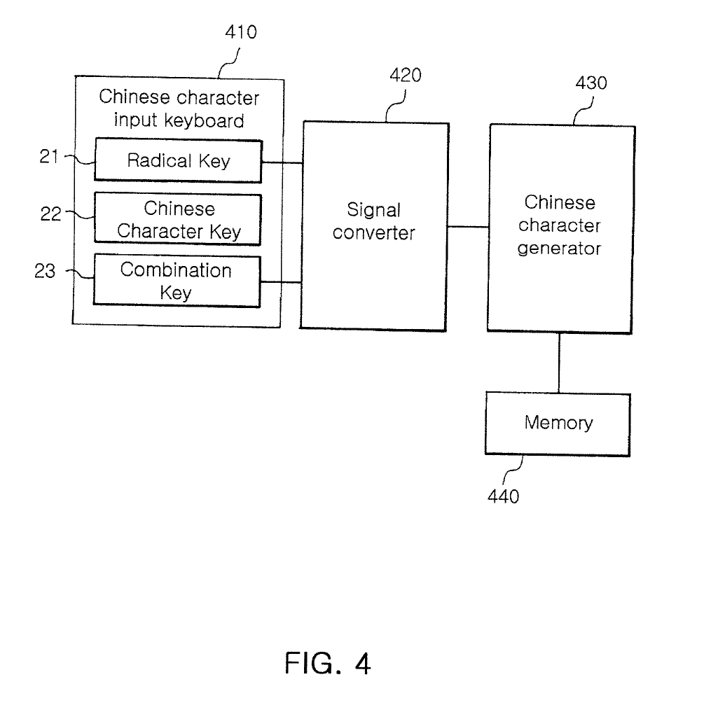

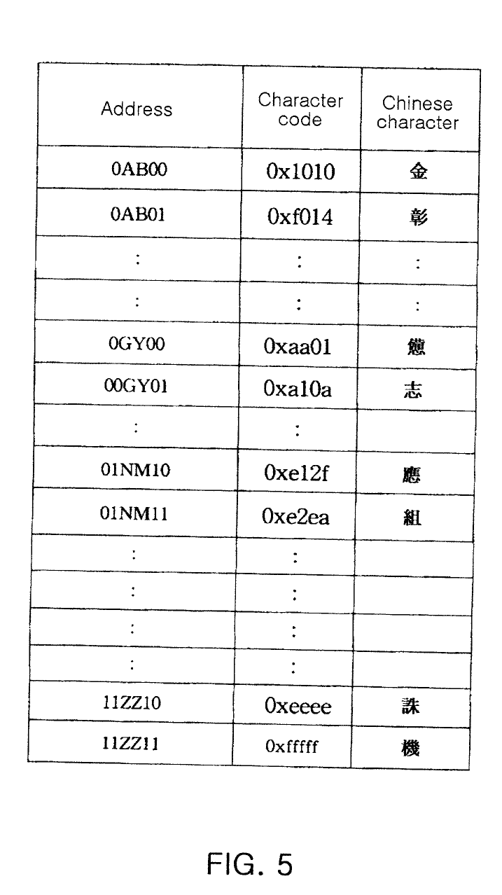

Referring now to FIG. 4, FIG. 4 depicts a schematic block diagram of system to which the keyboard may be applied according to the present invention. The keyboard of the prevent invention includes said radical key 21, Chinese character key 22 and combination key 23. A scan code generated by pressing the keys of the keyboard 410 is converted into a signal which can be processed in signal converter 420, and then is sent to Chinese character generator 430. The Chinese character generator 430 receives the converted code and designates a Chinese character stored in memory 440 by sequentially combining the codes, and then the designated Chinese character is inputted.

It should be noted that FIG. 4 shows a just Chinese character input system according to an exemplary embodiment of the present invention, and those of ordinary skill in the art will appreciate that the configuration, process and program of the system can be modified and replaced.

The operation of the Chinese character generator 430 can be implemented in a computer software or a microcomputer, and preferably can be implemented in a microprocessor.

Moreover, in operation of the system in FIG. 4, The radical key 21 represents radicals constituting a Chinese character, and the inputting of the radical key 21 results in the inputting radical. Wherein radical is inputted by directly pressing the radical key 21. For example, if a user whose name is

[symbol]

desires to input his name into information processing device, such as computer monitor, LCD, etc, it is possible for him to input ‘ [symbol] ’, ‘ [symbol] ’, ‘ [symbol] ’

one stroke each by direct strokes by using the radical key 21 respectively. Wherein signals corresponding to the inputted ‘ [symbol] ’, ‘ [symbol] ’

and ‘ [symbol] ’

are sent to the Chinese character generator 430 through the signal converter 420, and the Chinese character generator 430 generates the Chinese character ‘ [symbol] ’, ‘ [symbol] ’

and ‘ [symbol] ’

from the memory 440. The ‘ [symbol] ’, ‘ [symbol] ’

and ‘ [symbol] ’

are stored in the memory 440 in advance and are designated by the inputted ‘ [symbol] ’, ‘ [symbol] ’

and ‘ [symbol] ’.

The radical, which is inputted by the radical key 21, is classified into two types according to its usage. One is called ‘origin radical’, the other is called ‘Chinese character’. Those of ordinary skill in the art will appreciate that some Chinese characters can be used as radical, and there can be a case on the contrary too.

In addition, because a Chinese character is not written from left side to right side like English letters, the Chinese character is inputted by using the combination key 23 into device, such as a computer.

Referring now to ‘ [symbol] ’,

for example, if a user inputs the just radical key 21 representing ‘ [symbol] ’

and ‘ [symbol] ’

respectively, two Chinese characters, ‘ [symbol] ’

is inputted and displayed sequentially on a display such as a computer monitor. The result represents ‘WOMAN’. However, the ‘ [symbol] ’

is not ‘ [symbol] ’.

The ‘ [symbol] ’

does not represent ‘WOMAN’, but ‘LIKE’ or ‘WANT’. the ‘ [symbol] ’,

which is one Chinese character by itself, is composed of ‘ [symbol] ’

and ‘ [symbol] ’. Furthermore, the ‘ [symbol] ’

is combined by two character ‘ [symbol] ’

and ‘ [symbol] ’

in accordance with left-right configuration. In order to input the combined Chinese character ‘ [symbol] ’

into a display by inputting the radical keys 21 representing ‘ [symbol] ’

and ‘ [symbol] ’

respectively, the combination key 23.

The radical key 21 of ‘ [symbol] ‘

is inputted first, the combination key 23 of

[symbol]

which is displayed on the combination key 23 is then inputted, and then the radical key 21 of the rest character ‘ [symbol] ’

is inputted. The result is that the ‘ [symbol] ’

is designated by inputted radical key 21 of ‘ [symbol] ’,

the combination key 23 of [symbol] ,

and radical key 21 of ‘ [symbol] ’.

And the designated ‘ [symbol] ’,

which represents ‘LIKE’ or ‘WANT’ as depicted in above description, is generated from the memory 440 finally. The designated Chinese character was stored in the memory 440.

In this manner, it is also possible to input the Chinese character combined into up-down configuration. For example, in case of inputting ‘ [symbol] ’,

the radical key 21 of ‘ [symbol] ’

is inputted first, and the combination key 23 of

[symbol]

corresponding to the combination frame of ‘ [symbol] ’

is then inputted. The radical key 21 of the rest radical ‘ [symbol] ’

additionally is inputted by direct stroke. The result is that a completed Chinese character ‘ [symbol] ’,

which is designated by the inputted radical keys 21 representing ‘ [symbol] ’

and ‘ [symbol] ’,

and combination key 23 representing the combination frame [symbol] ,

is generated from the memory 440. Finally the Chinese character ‘ [symbol] ’

is inputted. Wherein, the Chinese character generator 430 generates a stored Chinese character ‘ [symbol] ’

by inputting the radical keys 21 of ‘ [symbol] ’

and ‘ [symbol] ’

and the combination key 23 of

[symbol]

from the memory 440. The present invention provides an efficient mechanism to input a Chinese character using both hands. The keyboard contains starting radicals coming firstly according to the order of strokes on the left side and connecting radicals coming the latter on the right side which are centered around the radical, ‘ [symbol] ’.

According to the present invention, it is easy to input Chinese characters by inputting the radical key representing the radical which constitutes a Chinese character and inputting the combination key representing the combination frame of the Chinese character, and it is possible to input a lot of Chinese characters for a specific time.

Furthermore, the present invention provides a simplified keyboard to compose Chinese character more rapidly and does not require more than five strokes as required in the prior art.

As is apparent from the foregoing, the present invention has an advantage in that the inventive keyboard can efficiently input Chinese characters. While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention includes all embodiments falling within the scope of the appended claims.

What is claimed:

1. A Chinese character input keyboard, wherein having a plurality of keys, inputting Chinese characters by sequentially pressing the keys, and said keyboard comprising:
a plurality of radical keys for representing radicals defined in the Kang-Hee Chinese Dictionary, and said radicals are classified into ‘Nature’, ‘Human’, ‘Living’, ‘Animal/Plant’ and ‘the Others’ group according to their meaning, wherein said groups are positioned on some portion of said keyboard respectively, and said radical keys are positioned close to each other; and
a plurality of combination keys for representing a combinative constructions of said radicals constituting a Chinese character.

2. The Chinese character input keyboard of claim 1, which further comprises a plurality of Chinese character keys for representing one more Chinese characters which are frequently used.

3. The Chinese character input keyboard of claim 2, wherein said Chinese character keys are located above said radical keys within said keyboard.

4. The Chinese character input keyboard of claim 2, wherein said Chinese character keys are located below said combination keys within said keyboard.

5. The Chinese character input keyboard of claim 2, wherein said Chinese character keys are located above said radical keys and below said combination keys within said keyboard.

6. The Chinese character input keyboard of claim 1, wherein said radical keys are composed of basic radical keys for representing basic radicals except specific radicals which can be formed by combining another radicals.

7. The Chinese character input keyboard of claim 1, wherein the number of said radical keys ranges between 146˜213.

8. The Chinese character input keyboard of claim 1, wherein said combination keys are provided at least one row above said radical keys.

9. The Chinese character input keyboard of claim 1, wherein the number of said combination keys ranges between 20˜35.

10. The Chinese character input keyboard of claim 1, wherein said radical keys comprise a radical, ‘ [symbol] ’, in the middle of thereon.

11. The Chinese character input keyboard of claim 1, wherein the first radical keys according to the order of strokes of a Chinese character are positioned on the left side of said keyboard.

12. The Chinese character input keyboard of claim 1, wherein said ‘Nature’ group of said radical keys is further divided into ‘Recognition’ and ‘Natural object’ subgroup, and radical keys of said each subgroup are positioned close to each other.

13. The Chinese character input keyboard of claim 12, wherein said ‘Recognition’ subgroup is further divided into ‘Number’ and ‘Size’ subgroup, and radical keys representing ‘Number’ are located upper center portion of said radical keys section within said keyboard.

14. The Chinese character input keyboard of claim 1, wherein said ‘Human’ group of said radical keys is further divided into ‘Life’ and ‘Body’ subgroup, and radical keys of said each subgroup are positioned close to each other.

15. The Chinese character input keyboard of claim 1, wherein said ‘Living’ group of said radical keys is further divided into ‘Clothing/Food/Shelter’ and ‘Artificial’ subgroup, and radical keys of said each subgroup are positioned close to each other.

16. The Chinese character input keyboard of claim 1, wherein said ‘Animal/Plant’ group of said radical keys is further divided into ‘Animal’ and ‘Plant’ subgroup, and radical keys of said each subgroup are positioned close to each other.

17. The Chinese character input keyboard of claim 1, wherein said radical keys comprise specific radical keys representing radicals which have different types with radicals defined in the Kang-Hee Chinese Dictionary, although the same meaning.

18. A Chinese character input keyboard, wherein having a plurality of keys, inputting Chinese characters by sequentially pressing the keys, and said keyboard comprising:
a plurality of radical keys for representing radicals defined in the Kang-Hee Chinese Dictionary, and said radicals are classified into ‘Nature’, ‘Human’, ‘Living’, ‘Animal/Plant’ and ‘the Others’ group according to their meaning, wherein said groups are positioned on some portion of said keyboard respectively, and said radical keys are positioned close to each other;
a plurality of combination keys for representing a combinative constructions of said radicals constituting a Chinese character;
a plurality of Chinese character keys for representing one more Chinese characters which are frequently used.

19. The Chinese character input keyboard of claim 18, wherein said Chinese character keys are located above said radical keys within said keyboard.

20. The Chinese character input keyboard of claim 18, wherein said Chinese character keys are located below said combination keys within said keyboard.

21. The Chinese character input keyboard of claim 18, wherein said Chinese character keys are located above said radical keys and below said combination keys within said keyboard.

22. The Chinese character input keyboard of claim 18, wherein said radical keys are composed of basic radical keys for representing basic radicals except specific radicals which can be formed by combining another radicals.

23. The Chinese character input keyboard of claim 18, wherein the number of said radical keys ranges between 146˜213.

24. The Chinese character input keyboard of claim 18, wherein said combination keys are provided at least one row above said radical keys.

25. The Chinese character input keyboard of claim 18, wherein the number of said combination keys ranges between 20˜35.

26. The Chinese character input keyboard of claim 18, wherein said radical keys comprise a radical, ‘ [symbol] ’, in the middle of thereon.

27. The Chinese character input keyboard of claim 18, wherein the first radical keys according to the order of strokes of a Chinese character are positioned on the left side of said keyboard.

28. The Chinese character input keyboard of claim 18, wherein said ‘Nature’ group of said radical keys is further divided into ‘Recognition’ and ‘Natural object’ subgroup, and radical keys of said each subgroup are positioned close to each other.

29. The Chinese character input keyboard of claim 28, wherein said ‘Recognition’ subgroup is further divided into ‘Number’ and ‘Size’ subgroup, and radical keys representing ‘Number’ are located upper center portion of said radical keys section within said keyboard.

30. The Chinese character input keyboard of claim 18, wherein said ‘Human’ group of said radical keys is further divided into ‘Life’ and ‘Body’ subgroup, and radical keys of said each subgroup are positioned close to each other.

31. The Chinese character input keyboard of claim 18, wherein said ‘Living’ group of said radical keys is further divided into ‘Clothing/Food/Shelter’ and ‘Artificial’ subgroup, and radical keys of said each subgroup are positioned close to each other.

32. The Chinese character input keyboard of claim 18, wherein said ‘Animal/Plant’ group of said radical keys is further divided into ‘Animal’ and ‘Plant’ subgroup, and radical keys of said each subgroup are positioned close to each other.

33. The Chinese character input keyboard of claim 18, wherein said radical keys comprise specific radical keys representing radicals which have different types from radicals defined in the Kang-Hee Chinese Dictionary, although the same meaning.
